(19) United States
(12) Patent Application Publication
(10) Pub. No.: US 2018/0128001 A1
(43) Pub. Date: May 10, 2018

(54) METHOD FOR OPERATING A LOADING FACILITY AND LOADING FACILITY

(71) Applicant: Robert Bosch GmbH, Stuttgart (DE)

(72) Inventors: Juergen Auracher, Oberstenfeld (DE); Stefan Nordbruch, Kornwestheim (DE)

(21) Appl. No.: 15/569,041

(22) PCT Filed: Apr. 12, 2016
(86) PCT No.: PCT/EP2016/058018

§ 371 Date: Oct. 24, 2017

(30) Foreign Application Priority Data
Jun. 16, 2015 (DE) 10 2015 210 989.5

(51) Int. Cl. E04H 6/12; G08G 1/14

(52) U.S. Cl. CPC E04H 6/12; G08G 1/146; G06Q 50/28; G08G 1/144; G08G 1/143

(57) ABSTRACT

A method for operating a loading facility for vehicles including a plurality of loading sites, each loading site having a parking occupancy sensor for detecting a state of occupancy of the respective loading site, including detecting a current state of occupancy of the loading sites with the aid of the respective parking occupancy sensor, and operating the loading facility based on the detected states of occupancy. A loading facility as well as a computer program are also described.

### FIELD

The present invention relates to a method for operating a loading facility for vehicles including a plurality of loading sites. The present invention also relates to a loading facility for vehicles. In addition, the present invention relates to a computer program.

### BACKGROUND INFORMATION

Conventional parking sensors detect a state of occupancy of a parking position in a parking facility. For example, such parking sensors are adhered or bolted onto a pavement of a parking area, so that the parking sensors thus placed are able to detect when a vehicle is or is not parked over them.

Generally, logistics companies operate a loading facility for the loading of products or goods. In such a loading facility, there may be halls with loading sites, for example. In particular, within such a loading facility, there may be parking areas for the temporary parking of transport vehicles.

A control sequence for a loading operation is, for example, that a transport vehicle comes to a hall. For example, a driver of the transport vehicle does not know to which loading site he must drive. For that, a driver of the transport vehicle must generally inquire at what is referred to as a coordinator. Such a coordinator typically coordinates loading within the loading facility. Therefore, the coordinator usually knows the loading site to which the transport vehicle must drive. However, generally, the coordinator does not know whether the loading site is already free or whether it is still occupied by another transport vehicle. It may be time-consuming to check this out since, for example, the coordinator himself must go to the loading site.

After being loaded, the transport vehicle usually leaves its loading site and, for example, drives out of the loading facility or out of the hall again through a gate. A driver of the transport vehicle generally informs the coordinator that he is leaving. Generally, this is done personally by the driver himself. Sometimes, however, the driver may also forget to make such a notification. In other words, a situation may thus arise where the coordinator believes that a loading site is still occupied, but the loading site itself is available.

After the loading, it may also be, for example, that the transport vehicle is to be parked for the time being, thus, temporarily, in a parking area within the loading facility. It may be that the transport vehicle is also supposed to be taken over by a different driver at a later time. To that end, it is expedient that the transport vehicle be driven to a parking area in order to be parked there. In this case, there is also a need to know whether the parking area is free or occupied.

Furthermore, logistics companies which operate a loading facility require that processes have the ability to be automated and also subsequently analyzed, so that if necessary, the processes are able to be optimized.

### SUMMARY

An object of the present invention includes providing for the efficient operation of a loading facility for vehicles including a plurality of loading sites.

This objective may be achieved in accordance with the present invention. Advantageous developments of the present invention are described herein.

According to one aspect, a method is provided for operating a loading facility for vehicles including a plurality of loading sites, each loading site having a parking occupancy sensor for detecting a state of occupancy of the respective loading site, including the following steps:
Detecting a current state of occupancy of the loading sites with the aid of the respective parking occupancy sensor,
Operating the loading facility based on the detected states of occupancy.

According to a further aspect, a loading facility for vehicles is provided, the loading facility being designed to carry out the method according to the present invention.

According to another aspect, a computer program is provided which includes program code for carrying out the method according to the present invention when the computer program is executed on a computer.

Thus, specifically and among other things, the present invention includes the idea of using parking occupancy sensors to ascertain whether a loading site is available or occupied. According to the present invention, it is then provided to operate the loading facility based on this information. In particular, this results in the technical advantage that the loading facility is able to be operated efficiently, for a coordinator thus no longer has to go himself to a loading site to determine whether or not the loading site is free, for example. As a consequence, time is saved in advantageous manner.

A loading facility within the meaning of the present invention denotes a technical apparatus with which goods are able to be loaded. In particular, loading includes loading of a vehicle. Loading especially includes unloading of a vehicle.

For example, the loading facility may be encompassed by a goods transfer location. For instance, the loading facility is included in a port, e.g., a ship harbor or an airport.

The vehicle is a land vehicle, for example, or a water craft or an aircraft. For instance, a land vehicle is a motor vehicle, e.g., a passenger car (PC) or a truck (TRK).

A loading facility includes a warehouse, for example, having a plurality of loading gates at which vehicles are able to stop for the purpose of loading. Such places are loading sites, for instance.

A loading site includes a loading ramp, for example. A loading ramp may also be referred to as a loading bay and is used for the loading and unloading of vehicles.

For instance, a loading facility includes a warehouse which, e.g., has loading gates, each having a dock leveler.

According to one specific embodiment, a plurality of parking occupancy sensors are provided. In other words, for instance, one or more loading sites may thus in each case include one or more parking occupancy sensors.

By way of example, a parking occupancy sensor is one of the following sensors: radar sensor, lidar sensor, laser sensor, ultrasonic sensor, video sensor or magnetic sensor. Namely, such sensors are thus surround-field sensors, by which a surrounding area is able to be detected by sensors.

In one specific embodiment, based on the detected states of occupancy of the loading sites, it is determined whether one of the loading sites is free, and if one of the loading sites is free, the operation includes an assignment of the free loading site to a vehicle.

In particular, this brings with it the technical advantage that the vehicle is able to drive to a free loading site, without a driver of the vehicle having to go himself to the loading site in order to check whether the loading site is available or occupied. Consequently, the situation can also no longer occur, where the vehicle drives to a loading site assigned to it, arrives there, but the driver has to find out that the loading site is still occupied. Therefore, time may be saved in advantageous manner. In particular, loading is able to be carried out efficiently.

A free loading site within the meaning of the present invention denotes a loading site at which no vehicle is parked for the purpose of loading. The loading site is thus free of a vehicle.

An occupied loading site within the meaning of the present invention denotes a loading site at which a vehicle is parked for the purpose of loading. In other words, at an occupied loading site, a vehicle is thus parked.

In a further specific embodiment, the operation includes transmission of a position of the free loading site via a communication network to a user of the communication network.

Notably, this yields the technical advantage that the position of the free loading site may be made available efficiently to the user of the communication network. For instance, the user of the communication network may be a terminal device, e.g., a mobile terminal device, e.g., a cell phone, especially a smart phone. The terminal device may be assigned to a driver of the vehicle, for example. In this way, the driver of the vehicle thus knows where the free loading site is located within the loading facility. For reasons of simplification, the driver may be referred to here as the user.

For example, the terminal device may be located within the vehicle or on the vehicle, in general, be included by the vehicle. In this case, for instance, for convenience, the vehicle itself may then be referred to as user. Thus, the vehicle knows where the loading site is located and, for example, may communicate this to the driver or, for instance, may drive autonomously to the loading site.

In a further specific embodiment, the operation includes that a route from a starting position to the loading site assigned to the vehicle is transmitted via a communication network to a user of the communication network.

Namely, this results in the technical advantage that the user of the communication network may be informed efficiently as to how he/it is able to get from the starting position to the loading site. As explained above, the user may be a terminal device here, as well. For instance, the user may be assigned to the driver of the vehicle. For example, the vehicle may be the user of the communication network. Therefore, for instance, the vehicle itself is able to drive autonomously to the loading site based on the route.

For instance, a starting position is an entrance to the loading facility, e.g., an entry gate.

The starting position may correspond to a present position of the vehicle, for example.

According to one specific embodiment, the communication network includes a cellular network and/or a WLAN network.

According to one specific embodiment, a communication via the communication network becomes or rather is encoded.

The formulation “or rather” includes the formulation “and/or.”

According to a further specific embodiment, based on the detected states of occupancy of the loading sites, it is determined whether a vehicle has arrived at a loading site or has left a loading site, the operation including actuation of a gate and/or operation of a lighting system and/or operation of loading equipment when the vehicle has arrived at the loading site or has left the loading site.

Specifically, this brings about the technical advantage that, for example, a gate and/or a lighting system and/or loading equipment may be operated efficiently, for as a rule, the elements or items indicated above do not have to be operated or actuated until the vehicle approaches the loading site and/or the vehicle leaves the loading site. Notably, in this manner, operation or actuation of the aforesaid elements may advantageously be coordinated efficiently, especially timewise, with the arrival of the vehicle at and/or the departure of the vehicle from the loading site.

The actuation of the gate includes, e.g., opening or closing of the gate.

The operation of a lighting system includes, e.g., activation or deactivation of the lighting system or individual elements of the lighting system.

The operation of loading equipment includes, e.g., activation or deactivation of the loading equipment or individual elements of the loading equipment. For instance, the loading equipment may include a loading crane that may be moved to the loading site or moved away again from the loading site after loading is completed. The loading equipment includes a loading ramp, for example, which, e.g., may be lowered or raised.

According to one specific embodiment, the operation includes that goods to be loaded are sent to a loading site assigned to a vehicle. Notably, this occurs when, based on the detected states of occupancy of the loading sites, it is determined whether a vehicle has arrived at a loading site. Specifically, this yields the technical advantage that a waiting time until the goods to be loaded have arrived at the loading site may be reduced for the vehicle and the driver.

In one specific embodiment, the operation includes that a request is transmitted via a communication network, to the effect that loading personnel should move to a loading site assigned to a vehicle. Specifically, this occurs when, based on the detected states of occupancy of the loading sites, it is determined whether a vehicle has arrived at a loading site.

Namely, this provides the technical advantage that a waiting time until the loading personnel have arrived at the loading site may be reduced for the vehicle and the driver.

According to a further specific embodiment, the operation includes transmission of the detected states of occupancy to a server via a communication network.

Specifically, this yields the technical advantage that the detected states of occupancy are available centrally on the server. For instance, the server is advantageously able to make the detected states of occupancy available efficiently to clients. Users of the communication network are able to retrieve the detected states of occupancy directly from the server at any time, for example. In particular, the server is able to operate the loading facility based on the detected states of occupancy.

That is, for example, according to one specific embodiment, the server is thus designed to operate the loading facility based on the detected states of occupancy.

According to one specific embodiment, the loading facility therefore includes a server.

In another specific embodiment, a loading time at the respective loading sites is determined based on the detected states of occupancy.

This especially yields the technical advantage that loading time at the respective loading sites may be determined efficiently. As a consequence, processes may be optimized, for example. In particular, loading processes may be analyzed. For instance, a loading process may then be optimized advantageously based on such an analysis.

In another specific embodiment, based on the detected states of occupancy, it is determined whether one of the loading sites is occupied, and if one of the loading sites is occupied, the operation includes the monitoring of loading at the occupied loading site with the aid of a sensor system.

In particular, this yields the technical advantage that loading may be monitored efficiently at the occupied loading site, for only when a loading site is recognized as occupied does loading also usually take place at this loading site. Only then is it technically useful to monitor a loading, for generally no loading can take place at a free loading site. Therefore, no loading can then be monitored there, either.

Monitoring the loading makes it possible, for example, to efficiently determine what progress has already been made in the loading. For instance, it may thereby be determined how long the loading is still likely to take. Consequently, for example, the loading facility may be operated efficiently in advantageous manner.

For example, the sensor system for monitoring the loading includes one or more surround-field sensors, e.g., a video sensor or, e.g., one of the surround-field sensors indicated above.

According to a further specific embodiment, the loading facility encompasses a plurality of parking areas, each of which includes a parking occupancy sensor for detecting a state of occupancy of the respective parking area, a current state of occupancy of the parking areas being determined with the aid of the respective parking occupancy sensor, the operation including that the loading facility is operated based on the detected states of occupancy of the parking areas.

In particular, this yields the technical advantage that it is possible to ascertain efficiently whether a parking area is free or occupied. Because the loading facility is operated based on the detected states of occupancy, this especially ensures the technical advantage that the loading facility may be operated efficiently, for a coordinator or a driver of a vehicle no longer has to go himself to the parking area, for example, to check whether the parking area is free or occupied. Advantageously, time may thus be saved.

In another specific embodiment, steps included by the operation step are documented electronically.

Notably, this yields the technical advantage that the steps encompassed by the operation step may also be reproduced at a later point in time. For instance, this may be technically relevant for an analysis of the operation of the loading facility. In particular, advantageously, the individual steps of the process may thereby also be optimized afterwards.

For instance, the electronic documenting includes electronic storage or recording.

In a further specific embodiment, the loading facility encompasses a plurality of parking areas, each of which includes a parking occupancy sensor for detecting a state of occupancy of the respective parking area. For instance, a plurality of parking occupancy sensors are included by one or more parking areas.

According to one specific embodiment, the loading facility includes a plurality of loading sites, each loading site having one or more parking occupancy sensors for detecting a state of occupancy of the respective loading site.

The present invention is described in greater detail below on the basis of preferred exemplary embodiments.

### BRIEF DESCRIPTION OF THE DRAWINGS

FIG. 1 shows a flowchart of a method for operating a loading facility.

FIG. 2 shows a loading facility for vehicles.

### DETAILED DESCRIPTION OF EXAMPLE EMBODIMENTS

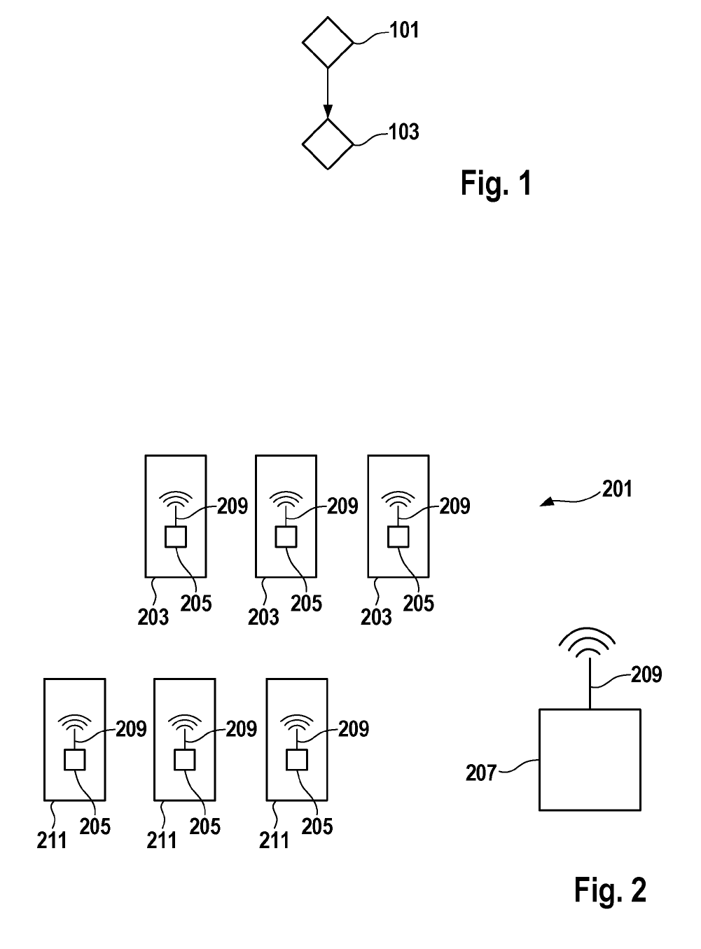

FIG. 1 shows a flowchart of a method for operating a loading facility for vehicles including a plurality of loading sites, each loading site having a parking occupancy sensor for detecting a state of occupancy of the respective loading site.

According to a step 101, a current state of occupancy of the loading sites is detected with the aid of the respective parking occupancy sensor. In a step 103, the detected states of occupancy are used to operate the loading facility. In other words, according to step 103, the loading facility is thus operated based on the detected states of occupancy.

For example, in one specific embodiment not shown, based on the detected states of occupancy of the loading sites, it is determined whether one of the loading sites is free, and if one of the loading sites is free, the operation includes an assignment of the free loading site to a vehicle.

For instance, in a further specific embodiment not shown, a position of the free loading site is transmitted via a communication network to a user of the communication network.

The position of the free loading site is transmitted to the vehicle, for example.

FIG. 2 shows a loading facility 201 for vehicles.

Loading facility 201 includes a plurality of loading sites 203. Each loading site 203 includes a parking occupancy sensor 205. Parking occupancy sensor 205 is designed to detect a state of occupancy of respective loading site 203.

Parking occupancy sensors 205 in each case include a wireless communication interface 209.

In one specific embodiment not shown, in addition to or instead of the wireless communication interface, a wire-bound communication interface may be provided.

Therefore, according to one specific embodiment, each parking occupancy sensor 205 includes a communication interface, which is designed to communicate via a wire-bound and/or wireless communication network.

Loading facility 201 also includes a server 207 that contains a wireless communication interface 209. Here as well, in a specific embodiment not shown, server 207 may include a wire-bound communication interface in addition to or instead of wireless communication interface 209.

Parking occupancy sensors 205 transmit the detected state of occupancy of their assigned loading site 203 via a wireless communication network to server 207. Based on the detected states of occupancy, server 207 is able to control, especially coordinate, an operation of loading facility 201.

In particular, based on the detected states of occupancy, server 207 is able to determine which of loading sites 203 is free. For instance, a free loading site may then be assigned by server 207 to a vehicle. For example, server 207 is able to transmit the position of the free loading site via the wireless communication network to the vehicle. Server 207 is able to determine a route from a starting position to the free loading site, thus, to the position of the free loading site, for example, and transmit this determined route to the vehicle via the wireless communication network, as well.

Loading facility 201 also includes a plurality of parking areas 211, in which vehicles are able to park. Parking areas 211 in each case include a parking occupancy sensor 205, each containing a wireless communication interface 209. Parking occupancy sensors 205 of parking areas 211 are thus advantageously able to detect a state of occupancy of parking areas 211. In particular, these detected states of occupancy may then likewise be transmitted to server 207 via the wireless communication network. Server 207 is then able to control the operation of loading facility 201 efficiently based on these detected states of occupancy. For instance, server 207 is able to assign a free parking area to a vehicle.

Thus, loading facility 201 is designed or equipped to carry out or implement the method for operating a loading facility for vehicles including a plurality of loading sites, each loading site having a parking occupancy sensor for detecting a state of occupancy of the respective loading site.

According to one specific embodiment, the loading facility is encompassed by a logistics company.

According to one specific embodiment, the loading facility is encompassed by a vehicle fleet company.

In accordance with the present invention, parking occupancy sensors are used to detect states of occupancy of loading sites and especially of parking areas, so that based on the detected states of occupancy, special evaluation methods may be carried out and/or used and/or expanded with the detected states of occupancy, in order to optimize logistics- and/or loading- and/or analysis processes.

In accordance with the present invention, based on the results of the parking occupancy sensors, which, e.g., may form a parking occupancy system, fleet procedures and/or logistics procedures within the loading facility may additionally be automated and/or optimized and/or expanded.

According to one specific embodiment, the parking areas and the loading sites are equipped with parking occupancy sensors.

In this manner, for example, advantageously a coordinator and/or a fleet management system always knows online the state of occupancy of the individual parking areas and/or loading sites. In particular, it is thereby also advantageously known when a vehicle drives away again after being loaded. Consequently, it is also specifically known when a loading process has ended.

On the basis of the state of occupancy, according to one specific embodiment, the loading site assigned to a vehicle is communicated to the vehicle and/or the driver automatically and specific to the situation. For example, this is accomplished via a vehicle communication system or a fleet communication system (e.g., a truck communication system) and/or via a mobile terminal device and/or by a telephone call to the coordinator and/or by an automatic telephone answering system.

According to one specific embodiment, a route to the loading site is transmitted automatically to the driver and/or the vehicle. The route is used advantageously as a navigation aid.

According to a further specific embodiment, in the same way, thus, analogous to what was explained above in connection with the loading site, a parking area as well as, according to a further specific embodiment, a route to it are assigned and/or communicated to the vehicle and/or the driver.

In a further specific embodiment, necessary processes are initiated at the loading site in accurately timed fashion. In other words, for example, when it has been determined automatically that the vehicle has arrived at and/or has driven away from the loading site, gates are opened or closed, for instance. For example, lighting means may be switched on or off. Loading personnel may be suitably coordinated, for instance. Special loading equipment may be reserved, for example, and made available at the right time.

In a further specific embodiment, all processes are analyzed statistically, in particular, are analyzed automatically. That is, for example, the length of time a loading takes is analyzed.

The length of time a vehicle was at a loading gate or a loading site may be determined or analyzed, for instance.

In this manner, logistics processes may advantageously be improved and/or optimized. For instance, the length of time a loading process takes on average may be determined.

In a further specific embodiment, at the loading locations, additional sensors are mounted which are used for checking and/or for further processes. In this context, one process, for example, is a check of a status of the loading. For instance, it is thus checked how much merchandise or freight has already been loaded. For example, the sensors include visual sensors, e.g., cameras.

According to one specific embodiment, all data and sequences are documented.

1-14. (canceled)

15. A method for operating a loading facility for vehicles, the loading facility including a plurality of loading sites, each loading site having a parking occupancy sensor for detecting a state of occupancy of the respective loading site, the method comprising:
detecting a current state of occupancy of the loading sites with the aid of the respective parking occupancy sensor; and
operating the loading facility based on the detected states of occupancy.

16. The method as recited in claim 15, wherein based on the detected states of occupancy of the loading sites, determining whether one of the loading sites is free, and, if one of the loading sites is free, the operation includes an assignment of the free loading site to a vehicle.

17. The method as recited in claim 16, wherein the operation includes transmitting a position of the free loading site via a communication network to a user of the communication network.

18. The method as recited in claim 16, wherein the operation includes transmitting a route from a starting position to the loading site assigned to the vehicle via a communication network to a user of the communication network.

19. The method as recited in claim 16, wherein the operation includes moving goods to be loaded to the loading site assigned to the vehicle.

20. The method as recited in claim 16, wherein the operation includes transmitting a request via a communication network, to the effect that loading personnel should move to the loading site assigned to the vehicle.

21. The method as recited in claim 15, further comprising:
based on the detected states of occupancy of the loading sites, determining whether a vehicle has arrived at a loading site or has left a loading site, the operation including at least one of: (i) actuating a gate, (ii) operating a lighting system, and (iii) operating loading equipment, when the vehicle has arrived at the loading site or has left the loading site.

22. The method as recited in claim 15, wherein the operation includes transmitting the detected states of occupancy to a server via a communication network.

23. The method as recited in claim 15, wherein a loading time at the respective loading sites is determined based on the detected states of occupancy.

24. The method as recited in claim 15, further comprising:
based on the detected states of occupancy, determining whether one of the loading sites is occupied, and if one of the loading sites is occupied, the operation includes monitoring loading at the occupied loading site with the aid of a sensor system.

25. The method as recited in claim 15, wherein the loading facility encompasses a plurality of parking areas, each including a parking occupancy sensor for detecting a state of occupancy of the respective parking area, a current state of occupancy of the parking areas being determined with the aid of the respective parking occupancy sensor, the operation including operating the loading facility based on the detected states of occupancy of the parking areas.

26. The method as recited in claim 15, wherein steps included by the operating step are documented electronically.

27. A loading facility for vehicles, the loading facility including a plurality of loading sites, each loading site having a parking occupancy sensor for detecting a state of occupancy of the respective loading site, the loading facility designed to:
detect a current state of occupancy of the loading sites with the aid of the respective parking occupancy sensor; and
operate the loading facility based on the detected states of occupancy

28. A non-transitory computer-readable storage medium on which is stored a computer program, including program code for operating a loading facility for vehicles, the loading facility including a plurality of loading sites, each loading site having a parking occupancy sensor for detecting a state of occupancy of the respective loading site, the computer program, when executed by a processor, causing the processor to perform:
detecting a current state of occupancy of the loading sites with the aid of the respective parking occupancy sensor; and
operating the loading facility based on the detected states of occupancy.
